(19) United States
(12) Patent Application Publication
(10) Pub. No.: US 2024/0171863 A1
(43) Pub. Date: May 23, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yutaka Yamashita, Chiba (JP)

(21) Appl. No.: 18/514,782

(22) Filed: Nov. 20, 2023

(30) Foreign Application Priority Data
Nov. 22, 2022 (JP) 2022-186310

(51) Int. Cl. H04N 23/73; G06V 10/74; G06V 40/16

(52) U.S. Cl. CPC H04N 23/73; G06V 10/761; G06V 40/165; G06V 40/171; G06V 40/172; H04N 23/667

(57) ABSTRACT

An information processing apparatus detects a face region of a person included in a captured image, detects, from the face region in the captured image, a region of an item that the person wears, identifies a target face region obtained by excluding the region of the item from the face region in the captured image, determines, based on the target face region, an exposure correction amount relating to an exposure setting of an image capturing apparatus that obtains the captured image, and performs an exposure correction for the image capturing apparatus based on the determined exposure correction amount.

### BACKGROUND

### Technical Field

The present disclosure relates to an information processing technique for obtaining a correctly exposed image.

### Description of the Related Art

A technique of detecting a specific region of an object from a captured image and capturing an image at correct exposure based on information of the detected specific region is discussed as one technique applied to image capturing apparatuses such as monitoring cameras, digital cameras, and video cameras. The specific region of the object is assumed to be a person's face region or the like.

Japanese Patent Application Laid-open No. 2005-86682 discusses a technique of detecting a face region from a captured image and adjusting pixel values of the captured image based on information obtained from the face region.

Japanese Patent Application Laid-open No. 2018-45386 discusses a technique of increasing brightness of an eye region, which tends to be dark, by adjusting exposures of a face region and the eye region to capture and combine the images thereof.

Japanese Patent Application Laid-open No. 2003-259189 discusses a technique of identifying a masking region for masking a region in which privacy is to be protected in an image and excluding the identified masking region from the target of image processing such as exposure correction.

In a case where a person in a captured image wears an item, such as a mask or sunglasses, on the face, the above-described techniques may fail to expose the face region correctly.

### SUMMARY

The present disclosure is directed to a technique for performing an exposure setting that enables obtaining a more correctly exposed face image even in a case where a person wears an item on the face.

According to an aspect of the present disclosure, an information processing apparatus includes one or more memories storing instructions, and one or more processors that, upon execution of the stored instructions, are configured to detect a face region of a person included in a captured image, detect, from the face region in the captured image, a region of an item that the person wears, identify a target face region obtained by excluding the region of the item from the face region in the captured image, determine, based on the target face region, an exposure correction amount relating to an exposure setting of an image capturing apparatus that obtains the captured image, and perform an exposure correction for the image capturing apparatus based on the determined exposure correction amount.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration according to an exemplary embodiment.

FIG. 2 is a functional block diagram of an information processing apparatus.

FIG. 3 is a block diagram illustrating a hardware configuration of the information processing apparatus.

FIGS. 4A and 4B are diagrams illustrating an example of a face region obtained as a face detection result.

FIGS. 5A and 5B are diagrams illustrating an example of a face region and a mask region obtained as a face detection result.

FIG. 6 is a flowchart illustrating information processing from image acquisition to exposure correction amount determination.

FIG. 7 is a flowchart illustrating information processing from image acquisition to person determination.

FIGS. 8A and 8B are tables illustrating tracking information obtained from each frame.

FIGS. 9A and 9B are diagrams illustrating an example of a face image of a person wearing both a mask and sunglasses.

### DESCRIPTION OF THE EMBODIMENTS

Exemplary embodiments of the present disclosure will be described below with reference to the attached drawings. The exemplary embodiments described below are not intended to limit the scope of the present disclosure, and not all combinations of features described in the exemplary embodiments are essential to the solution of the present disclosure. Configurations according to the exemplary embodiments can be modified or changed as appropriate based on specifications and various conditions (e.g., use conditions and use environments) of apparatuses to which the exemplary embodiments are applied. Further, parts of the exemplary embodiments described below may be combined as appropriate. In descriptions of the exemplary embodiments, the same reference numerals are assigned to the same components.

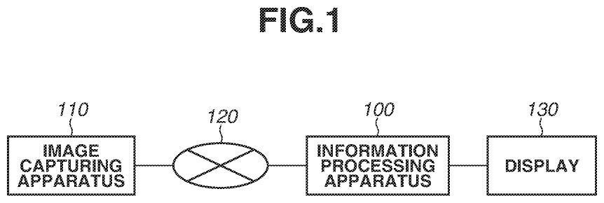

FIG. 1 illustrates a configuration example of a system to which an information processing apparatus 100 according to a first exemplary embodiment of the present disclosure is applied.

In the system illustrated in FIG. 1, the information processing apparatus 100 and an image capturing apparatus 110 are connected to each other via a network 120. The network 120 includes, for example, a plurality of routers, switches, and cables, which are compliant with a communication standard such as Ethernet®. The network 120 may be implemented by the Internet, a wired local area network (LAN), a wireless LAN, a wide area network (WAN), or the like.

The information processing apparatus 100 performs various kinds of information processing (described below), such as human body detection processing, face detection processing, person recognition processing, and human body tracking processing, on an image captured by the image capturing apparatus 110. The information processing apparatus 100 may include an estimation device for estimation using a face image. Based on an image of a face detected in the face detection processing (i.e., a face image), the estimation device performs information processing, such as estimating attributes including the age and gender of a person with the face and estimating the feeling of the person. In the present exemplary embodiment, the information processing apparatus 100 is implemented by a personal computer (PC) or the like on which programs for implementing these information processing functions are installed.

The image capturing apparatus 110 is a camera that captures an image of an object such as a person and is assumed to be a network camera connected to the network 120 in the present exemplary embodiment. The image capturing apparatus 110 associates image data of a moving image or a still image obtained by image capturing (hereinafter referred to as an image) with identification (ID) information (camera ID) for identifying the image capturing apparatus 110 and information about an image capturing time and an installation position, and transmits the data to the information processing apparatus 100 via the network 120. In the present exemplary embodiment, the image capturing apparatus 110 sets various image capturing parameters including an exposure setting of the image capturing apparatus 110 and issues an image capturing instruction, based on control commands transmitted from the information processing apparatus 100 via the network 120.

A display 130 is a display device such as a liquid crystal display (LCD). The display 130 is connected to the information processing apparatus 100 via a display cable compliant with a communication standard such as high-definition multimedia interface (HDMI®). In the present exemplary embodiment, the display 130 displays an image captured by the image capturing apparatus 110, a setting screen for use in information processing by the information processing apparatus 100, and an image obtained by the information processing. The display 130 and the information processing apparatus 100 may be provided in a single housing.

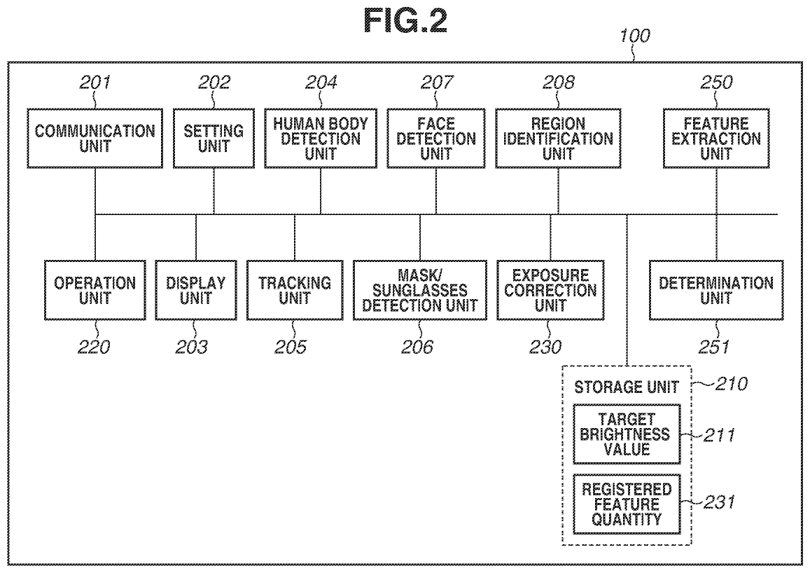

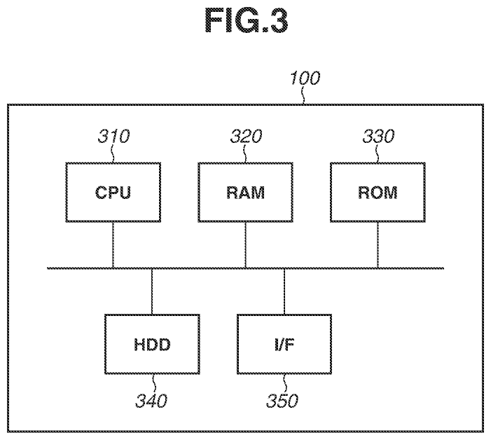

FIG. 2 is functional block diagram illustrating a configuration of functional units implemented in the information processing apparatus 100 according to the present exemplary embodiment. FIG. 3 is a block diagram illustrating an example of a hardware configuration of the information processing apparatus 100. Before the functional units illustrated in FIG. 2 are described, the hardware configuration in FIG. 3 will be briefly described.

In FIG. 3, a central processing unit (CPU) 310 performs overall control of the information processing apparatus 100 and calculations for various kinds of information processing. A read only memory (ROM) 330 stores an operating system (OS), various programs including an information processing program according to the present exemplary embodiment, data for an initial setting, and the like. The OS and the programs may be stored in a hard disk drive (HDD) 340. A random-access memory (RAM) 320 temporarily stores data in the middle of calculation, and a program to be executed by the CPU 310 is loaded into the RAM 320.

The HDD 340 is used to record various kinds of data such as image data. An interface (I/F) 350 is used to communicate with the network 120, the display 130, and the like. The information processing apparatus 100 according to the present exemplary embodiment is assumed to be a PC as described above, and thus includes general PC hardware not illustrated in FIG. 3.

With reference to the functional block diagram in FIG. 2, a description will be given of various kinds of information processing performed by the information processing apparatus 100 according to the present exemplary embodiment, such as the human body detection processing, the face detection processing, the person recognition processing, and the human body tracking processing. The information processing apparatus 100 according to the present exemplary embodiment detects a face region from an image captured by the image capturing apparatus 110, calculates an exposure amount for obtaining a correctly exposed image of the face region, and performs an exposure setting of the image capturing apparatus 110. Details thereof will be described below. The information processing apparatus 100 according to the present exemplary embodiment also performs wearing detection processing for detecting wearing of specific items, such as a mask covering a person's mouth and nose and sunglasses covering a person's eyes, in the face image detected from the captured image. Details thereof will be described below similarly to the above-described exposure setting. Based on a result of detecting the mask and/or the sunglasses, the information processing apparatus 100 calculates an exposure correction amount that enables a correct exposure setting for the face. The information processing apparatus 100 then performs the person recognition processing and the human body tracking processing, using the face image detected from the image captured by the image capturing apparatus 110 with the exposure setting performed based on the exposure correction amount. Thus, FIG. 2 illustrates the functional configuration example of the information processing apparatus 100 according to the present exemplary embodiment capable of implementing the information processing described above. The functional units illustrated in FIG. 2 are assumed to be implemented by the CPU 310 executing computer programs stored in the ROM 330 of the information processing apparatus 100, but a part or all of the functional units may be configured by circuitry or the like.

A communication unit 201 is implemented by the I/F 350 illustrated in FIG. 3 and communicates with the image capturing apparatus 110 via the network 120. More specifically, the communication unit 201 receives a captured image from the image capturing apparatus 110 and also transmits the above-described control commands generated by the CPU 310 to the image capturing apparatus 110.

A storage unit 210 is implemented by the RAM 320 or the HDD 340 illustrated in FIG. 3 and stores various kinds of information and data relating to various kinds of information processing performed by the information processing apparatus 100 according to the present exemplary embodiment. In the present exemplary embodiment, the information stored in the storage unit 210 includes a target brightness value 211 (described below), and a registered feature quantity 231 (described below) for use in the person recognition processing.

An operation unit 220 accepts information about an operation performed by a user using an operation input device (not illustrated) including a keyboard, a mouse, and a touch panel.

A setting unit 202 performs settings relating to various kinds of information processing performed by the information processing apparatus 100. For example, the setting unit 202 performs the settings based on instruction information input by the user via the operation unit 220. Examples of the instruction information input by the user include a brightness value (a target brightness value) as a target exposure value, a size and a detection position of a face to be detected from an image, a detection range, the number of faces to be detected, an execution instruction for the person recognition processing, an execution instruction for the human body tracking processing, a priority region to be processed preferentially, and an image capturing mode of the image capturing apparatus 110. Details of the information processing performed by the information processing apparatus 100 based on the instruction information will be described below.

A human body detection unit 204 performs processing of detecting a human body (a person) from a captured image. The human body detection unit 204 according to the present exemplary embodiment detects a human body appearing in an image by performing, for example, pattern matching using collation patterns (a dictionary) of human bodies. The result of the human body detection processing includes human body position information indicating a position at which the human body is present in the image, and face position information indicating a face position of the human body in the image.

The method for the human body detection processing is not, however, limited to the pattern matching. For example, the human body detection processing may be performed using a learning model obtained by deep learning that generates a feature quantity and a joint weighting factor for learning by itself using a neural network. In this way, the human body detection unit 204 according to the present exemplary embodiment can use various existing and available human body detection methods as appropriate.

A face detection unit 207 performs processing of detecting a face in a captured image. In the present exemplary embodiment, the face detection unit 207 detects a face of the human body detected by the human body detection unit 204. Similarly to the example of the human body detection processing, in the face detection processing by the face detection unit 207, available methods, such as a face detection method using pattern matching and a face detection method using a neural network, can be used as appropriate. In the face detection processing by the face detection unit 207, parts such as eyes, a nose, and a mouth are assumed to be detected in addition to a face position. Accordingly, the result of the face detection processing includes the result of detecting the parts such as the eyes, the nose, and the mouth in addition to the face position.

A feature extraction unit 250 extracts a feature quantity of a person from the face image of the person detected by the face detection unit 207 from the image captured by the image capturing apparatus 110. The feature quantity of the person is information usable to identify the person, and the feature extraction unit 250 extracts the feature quantity of the person using any of various existing feature quantity extraction methods.

A determination unit 251 performs the person recognition processing to determine whether a person with the face detected by the face detection unit 207 is a pre-registered person, based on the feature quantity of the person extracted by the feature extraction unit 250 and the feature quantity (the registered feature quantity 231) of the pre-registered person stored in advance in the storage unit 210.

The pre-registered person will hereinafter be referred to as the “registered person”. In the person recognition processing, the determination unit 251 collates the feature quantity of the person extracted by the feature extraction unit 250 with the registered feature quantity 231 stored in advance in the storage unit 210 and calculates a collation score indicating a degree of similarity between the detected person and the registered person. The collation score is information indicating that the higher the score is, the higher the degree of similarity is. In a case where the calculated collation score is higher than or equal to a score threshold value set and stored in advance in the storage unit 210, the determination unit 251 determines that the person with the face image detected by the face detection unit 207 is the same person as the registered person. It is desirable to change the score threshold value as appropriate depending on the image capturing environment, the registered image, and the use purpose. In addition, the user can set a desired score threshold value.

A tracking unit 205 performs the human body tracking processing by associating the human body detected by the human body detection unit 204 from the image captured at the current time with a human body detected in a previous image temporally preceding the current image. In the human body tracking processing, a tracking ID (a human body identifier) is assigned to each human body detected from images. In a case where the human body detected from the current image is a newly appearing human body that cannot be associated with a human body detected in a previous image, a new tracking ID is assigned to the human body in the current image. In a case where the human body detected from the current image can be associated with a human body detected in a previous image, the tracking ID assigned to the human body in the previous image is assigned to the human body in the current image. By assigning the tracking ID in this way, persons in images of frames (hereinafter referred to as frame images) continuous on a time axis are associated, whereby human body tracking information can be obtained.

The information processing apparatus 100 according to the present exemplary embodiment manages the person being tracked by the tracking unit 205 and the person collated by the determination unit 251 as the same person, by managing the results of the person determination processing by the determination unit 251 and the tracking ID assigned to each human body by the tracking unit 205 in association with each other. This makes it possible to reduce the risk of failing to notice or track the human body due to, for example, the face of the human body being hidden, and to continue tracking the same person.

A display unit 203 displays, on the display 130, the image corresponding to the image captured by the image capturing apparatus 110, the setting screen for making settings relating to various kinds of information processing by the information processing apparatus 100 described above, and information indicating the results of various kinds of information processing.

As described above, the information processing apparatus 100 according to the present exemplary embodiment performs the person recognition processing and the human body tracking processing based on the face image detected from the image captured by the image capturing apparatus 110.

In this case, the exposure of the face image of the person in the image affects the recognition accuracy in the person recognition processing. Thus, it is desirable to perform exposure correction to correctly expose the face image in the image.

However, with the existing exposure correction methods, in a case where a person wears an item such as a mask or sunglasses, it may be difficult to obtain a correctly exposed face image due to the influence of the mask and/or the sunglasses. For example, there are various kinds of masks with various colors, such as black and white, and/or patterns drawn thereon, and there are various kinds of sunglasses with dark or light colors or reflecting light. Thus, the existing exposure correction methods may fail to deal with the above-described issue. If a correctly exposed face image is unable to be obtained, the recognition accuracy of the person recognition processing using the face image may deteriorate.

The information processing apparatus 100 according to the present exemplary embodiment includes a mask/sunglasses detection unit 206, a region identification unit 208, and an exposure correction unit 230, in addition to the functional units described above, in order to perform an exposure setting that enables obtaining a correctly exposed face image even if a person wears a mask and/or sunglasses.

The mask/sunglasses detection unit 206 performs the wearing detection processing for detecting specific items from the face image of the person detected by the face detection unit 207. More specifically, the mask/sunglasses detection unit 206 performs processing of detecting at least one of a mask and sunglasses. Similarly to the examples of the human body detection processing and the face detection processing described above, in order to detect a mask and/or sunglasses, available methods, such as a detection method using the pattern matching and a detection method using the neural network, can be used as appropriate. The mask/sunglasses detection unit 206 according to the present exemplary embodiment is capable of detecting any kind of masks with various colors, such as black and white, and/or patterns drawn thereon, and any kind of sunglasses with dark or light colors or reflecting light.

The region identification unit 208 identifies, in the face of the person, a face region as an exposure correction target for which exposure is to be set correctly, based on the face detection result by the face detection unit 207 and the mask/sunglasses detection result by the mask/sunglasses detection unit 206. In a case where the mask/sunglasses detection unit 206 detects a mask and/or sunglasses, the region identification unit 208 identifies a region obtained by excluding a region of the mask and/or the sunglasses from the face image detected by the face detection unit 207, as the face region that is the exposure correction target. The face region identified as the exposure correction target will hereinafter be referred to as the “target face region”.

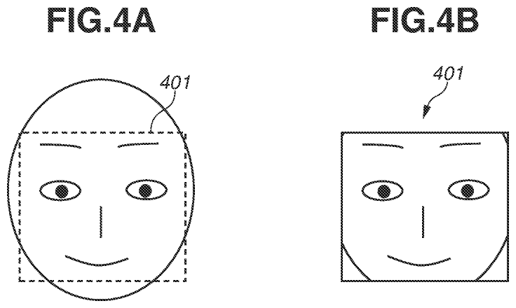

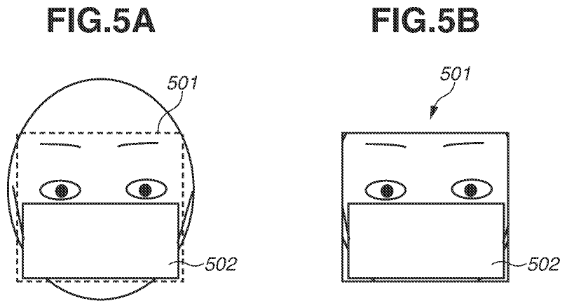

With reference to FIGS. 4A, 4B, 5A, and 5B, how to identify the face region as the exposure correction target will be described.

FIG. 4A illustrates an example of a face image obtained in the face detection processing by the face detection unit 207. FIG. 4B illustrates an example of a face region 401 identified by the region identification unit 208 from the face image in FIG. 4A. In the case of the face illustrated in FIG. 4A, the person does not wear a mask or sunglasses, so that the mask/sunglasses detection unit 206 does not detect a mask or sunglasses. Thus, the region identification unit 208 identifies the face region 401 in FIG. 4B as the target face region, i.e., the exposure correction target.

FIG. 5A illustrates an example of an image in a case where a face image is detected in the face detection processing by the face detection unit 207 and a mask region 502 is detected by the mask/sunglasses detection unit 206. FIG. 5B illustrates an example of a face region 501 identified by the region identification unit 208 from the face image in FIG. 5A. In the case of the face illustrated in FIG. 5A, the person wears a mask, so that the mask/sunglasses detection unit 206 detects the mask region 502.

Thus, the region identification unit 208 identifies a region obtained by excluding the mask region 502 from the face region 501 in FIG. 5B, as the target face region, i.e., the exposure correction target. Although not illustrated in FIGS. 5A and 5B, in a case where the mask/sunglasses detection unit 206 detects sunglasses, the region identification unit 208 identifies a face region obtained by excluding the region of the sunglasses from the face region 501, as the target face region.

The exposure correction unit 230 determines the exposure correction amount based on an average brightness value of the target face region identified by the region identification unit 208 as described above and the target brightness value 211 stored in advance in the storage unit 210. The determined exposure correction amount is then transmitted from the communication unit 201 to the image capturing apparatus 110. The transmission destination of the exposure correction amount may be an exposure control unit (not illustrated) provided in the information processing apparatus 100, instead of the image capturing apparatus 110. In this case, the exposure control unit in the information processing apparatus 100 controls the exposure amount setting of the image capturing apparatus 110 based on the exposure correction amount. The exposure setting of the image capturing apparatus 110 is performed based on the exposure correction amount through the transmission to one of the transmission destinations. In a case where a mask is detected as in the example of FIG. 5A, the exposure correction amount is determined based on the target face region that is the remaining region obtained by excluding the mask region 502 from the face region 501 as illustrated in FIG. 5B. As a result, the image capturing apparatus 110 can capture an image with a correct exposure setting based on the exposure correction amount determined from the target face region obtained by eliminating the influence of the mask.

Then, in the information processing apparatus 100 according to the present exemplary embodiment, the face detection unit 207 detects the face image from the image captured at correct exposure in which the influence of the mask and/or the sunglasses is reduced as described above, and the feature extraction unit 250 extracts the feature quantity from the face image. Further, the determination unit 251 performs the person recognition processing as described above. In this way, in the person recognition processing, it is possible to suppress the deterioration of the recognition accuracy described above by using the correctly exposed face image.

The determination unit 251 may be configured to not perform the above-described collation score calculation processing, i.e., not perform the person recognition processing in a case where the target face region identified by the region identification unit 208 is not within a setting range predetermined for the image or a setting range designated by the user. Further, the determination unit 251 may be configured to not perform the above-described collation score calculation processing in a case where the average brightness value of the target face region identified by the region identification unit 208 is not within a setting brightness range determined in advance or a setting brightness range designated by the user. In other words, the determination unit 251 determines whether the exposure of the target face region identified by the region identification unit 208 is correct, and if the exposure of the target face region is correct, the determination unit 251 may perform the collation score calculation processing, i.e., the person recognition processing. Through the above-described processing, it is possible to reduce the occurrence of erroneous recognition in the person recognition processing.

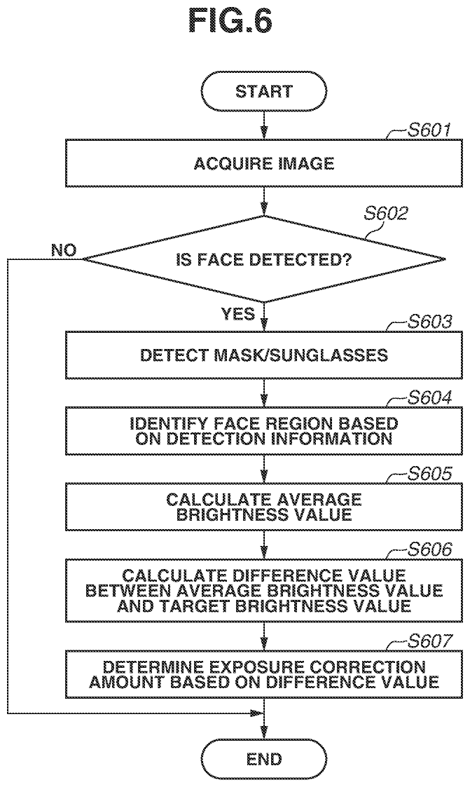

FIG. 6 is a flowchart illustrating a procedure for information processing from image acquisition to exposure correction amount determination performed by the information processing apparatus 100. In the flowcharts to be described below, “S” is added to the number of each processing step performed by the information processing apparatus 100. The processing of the flowchart in FIG. 6 is performed for each frame image.

In step S601, the communication unit 201 acquires an image captured by the image capturing apparatus 110 in units of frame images continuous on the time axis. At this time, the information processing apparatus 100 performs the above-described human body detection processing on each of the frame images acquired continuously on the time axis and acquires an image from the image capturing apparatus 110 based on the result of the human body detection processing.

In step S602, the face detection unit 207 performs the face detection processing on the image acquired in step S601 and determines whether a face is detected in the image. In a case where a face is detected in the image (YES in step S602), the processing proceeds to step S603. In a case where a face is not detected in the image (NO in step S602), the information processing apparatus 100 ends the processing on the current frame image, and the communication unit 201 acquires a next frame image. The information processing apparatus 100 then performs the processing of the flowchart in FIG. 6, on the newly acquired frame image.

In step S603, the mask/sunglasses detection unit 206 performs the mask/sunglasses detection processing on the face image detected by the face detection unit 207.

In step S604, the region identification unit 208 identifies the face region (the target face region) as the exposure correction target as described above, based on detection information indicating the result of the face detection processing by the face detection unit 207 and detection information indicating the result of the mask/sunglasses detection processing by the mask/sunglasses detection unit 206. In the present exemplary embodiment, in a case where the face detection unit 207 performs detection of parts such as eyes, a nose, and a mouth in the face detection processing, the region identification unit 208 may identify the target face region based on at least one of a position of each of parts such as eyes, a nose, and a mouth and a detection likelihood indicating a likelihood of each of the parts. In a case where the face detection unit 207 detects a plurality of face images, the region identification unit 208 may limit the number of target face regions to be identified as the exposure correction target. For example, the region identification unit 208 may determine the number of target face regions to be identified as the exposure correction target, based on at least one of a size (a face size) of each of the plurality of face images and a detected position (a detected face position) of each of the plurality of face images. One example thereof is that the number of target face regions may be reduced by excluding a face image having a size smaller than a size threshold and a face image whose detected position is outside a predetermined position range, from the face images from which the target face regions are to be identified.

In step S605, the exposure correction unit 230 calculates an average brightness value I_{blend} of the target face region identified by the region identification unit 208. For example, as illustrated in FIGS. 5A and 5B, in a case where the face region 501 and the mask region 502 are detected, the exposure correction unit 230 calculates the average brightness value I_{blend} of the target face region that is the remaining region obtained by excluding the mask region 502 from the face region 501.

In step S606, the exposure correction unit 230 calculates a difference value ΔDiff between a target brightness value I_{target} set in advance and the average brightness value I_{blend} calculated in step S605 based on the target face region identified in step S604, using an equation (1).

ΔDiff=I_{target}−I̅_{blend} (1)

The target brightness value I_{target} is the target brightness value 211 stored in the storage unit 210.

The target brightness value 211 may be a target value designated in advance by a user, or a fixed target value preset in a hardware device.

In step S607, the exposure correction unit 230 determines an exposure correction amount EV_{correction} using an equation (2) based on the difference value ΔDiff calculated in step S606, a threshold value Th set in advance, and a current exposure value EV_{current} of the image capturing apparatus 110.

$${EV}_{correction} = \{ \begin{matrix}{EV}_{current} - β & if Δ Diff < - Th \\ {EV}_{current} & if - Th \leq Diff \leq Th \\ {EV}_{current} + β & if Th < Δ Diff\end{matrix} \qquad ( 2 )$$

In the equation (2), the parameter β is an exposure step number that affects an exposure correction speed and is set so that the exposure correction amount EV_{correction} is on an underexposure side or an overexposure side with the current exposure value EV_{current} as a center value in a case where the difference value ΔDiff calculated in step S606 is outside the threshold value Th. If the parameter β is set to a large value, the exposure correction speed to reach the target brightness value I_{target} is high, but the brightness of the entire screen fluctuates greatly in a case where an erroneous determination occurs in the face detection result or in a case where the object detection result fluctuates. If the parameter β is set to a small value, the exposure correction speed to reach the target brightness value I_{target} is low, but the exposure correction is robust against the erroneous determination and the image capturing conditions.

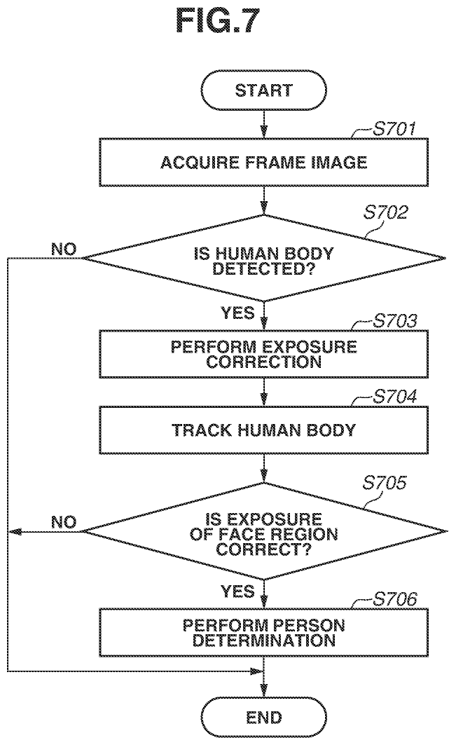

FIG. 7 is a flowchart illustrating a procedure for information processing in which the information processing apparatus 100 applies the exposure correction described above and performs the person recognition processing while tracking a person using frame images continuous on the time axis. The processing of the flowchart in FIG. 7 is performed for each frame image.

In step S701, the communication unit 201 acquires an image captured by the image capturing apparatus 110 in units of frame images continuous on the time axis.

In step S702, the human body detection unit 204 performs the human body detection processing on the frame image acquired in step S701 and determines whether a human body is detected in the frame image. In step $702, in a case where a human body is detected in the frame image (YES in step S702), the processing proceeds to step S703. In a case where a human body is not detected in the frame image (NO in step S702), the information processing apparatus 100 ends the processing on the current frame image, and the communication unit 201 acquires a next frame image. The information processing apparatus 100 then performs the processing of the flowchart in FIG. 7, on the newly acquired frame image.

In step S703, the information processing apparatus 100 performs the exposure correction based on the exposure correction amount EV_{correction} as described above.

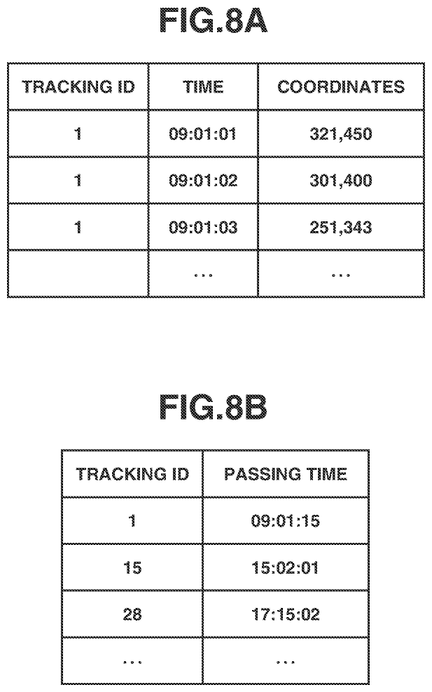

In step S704, the tracking unit 205 performs the human body tracking processing on the human body detected in step S702. At this time, the tracking unit 205 assigns a tracking ID to each detected human body as described above. This enables the same person appearing in the previous and next frames on the time axis can be associated with the tracking ID. FIG. 8A is a table illustrating an example of tracking information of the human body to which the tracking ID “1” is assigned. The tracking information includes times and coordinates as illustrated in FIG. 8A. FIG. 8B is a table illustrating an example of passing times of the human bodies to which different tracking IDs are assigned.

In step S705, the determination unit 251 determines whether the exposure of the target face region identified by the region identification unit 208 is correct as described above. More specifically, the determination unit 251 determines whether the above-described brightness difference value ΔDiff is within the threshold value Th set in advance. In a case where the brightness difference value ΔDiff is within the threshold value Th (YES in step S705), the processing proceeds to step S706. In a case where the brightness difference value ΔDiff is not within the threshold value Th (NO in step S705), the information processing apparatus 100 ends the processing on the current frame image, and the communication unit 201 acquires a next frame image. The information processing apparatus 100 then performs the processing of the flowchart in FIG. 7 on the newly acquired frame image.

In step S706, the determination unit 251 performs the person recognition processing (the person determination processing). In the present exemplary embodiment, as described above, the determination unit 251 performs the person recognition processing using the face feature quantity. The determination unit 251 compares the feature quantity extracted by the feature extraction unit 250 from the face image of the person detected by the face detection unit 207 as described above with the registered feature quantity 231 of the registered person stored in advance in the storage unit 210 and calculates a collation score indicating the degree of similarity between the detected person and the registered person. In a case where the collation score is the score threshold value or more, the determination unit 251 determines that the person with the detected face image and the registered person are the same person.

The score threshold value is set in advance, but, for example, different score threshold values may be set for a case where a mask is detected from a face image and a case where sunglasses are detected from a face image. In addition, the score threshold value may be set differently depending on the brightness difference value ΔDiff between the exposure of the identified target face region and the target brightness value I_{target}. After the processing in step S706, the information processing apparatus 100 ends the processing on the current frame image, and the communication unit 201 acquires a next frame image. The information processing apparatus 100 then performs the processing of the flowchart in FIG. 7 on the newly acquired frame image.

As described above, the information processing apparatus 100 according to the present exemplary embodiment can also track how the average brightness value I_{blend} of the face of the same person changes from frame to frame, by performing the human body tracking processing. In this way, the information processing apparatus 100 can use the determination unit 251 to perform the person recognition processing only on the face that is in a state where the average brightness value I_{blend} of the face of the same person is correct with respect to the target brightness value I_{target}. As a result thereof, the occurrence of the erroneous recognition in the person recognition processing can be expected to be reduced.

As described above, according to the present exemplary embodiment, it is possible to determine the exposure correction amount EV_{correction} that enables, even in a case where a person detected from an image wears a specific item such as a mask or sunglasses, a face image of the person to be captured at correct brightness. Thus, according to the present exemplary embodiment, it is possible to automatically perform a correct exposure setting for a face detected from a captured image, thereby enhancing the person recognition accuracy. Further, in the present exemplary embodiment, the exposure correction unit 230 can determine the exposure correction amount EV_{correction} depending on user's usage. In this way, in a case where a plurality of face images is detected in an image, it is possible to perform optimal exposure correction depending on the user's usage.

In a second exemplary embodiment, a description will be given of exposure correction in a case where a face region obtained by excluding the region of a mask and/or sunglasses from a face image does not satisfy a condition for enabling calculation of an effective exposure correction amount. A system configuration, a functional block configuration, and a hardware configuration in the second exemplary embodiment are similar to those according to the first exemplary embodiment illustrated in FIGS. 1, 2, and 3, and diagrams and descriptions thereof will thus be omitted.

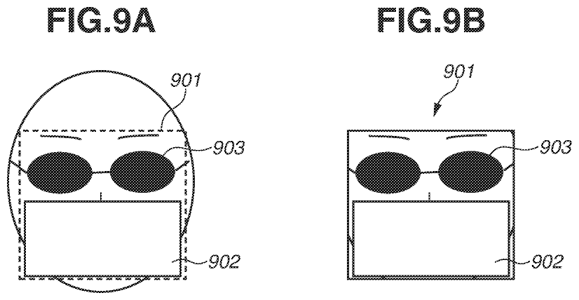

FIG. 9A illustrates an example of a face image of a person who wears both a mask and sunglasses.

FIG. 9B illustrates an example of a face region 901 identified by the region identification unit 208 from the face image in FIG. 9A. In this example, the target face region identified by the region identification unit 208 is the remaining region obtained by excluding a mask region 902 and a sunglasses region 903 from the face region 901. However, in a case where a person wears both a mask and sunglasses as illustrated in FIG. 9B, the target face region is extremely small since the mask region 902 and the sunglasses region 903 are excluded. In other words, there is a possibility that the target face region may not satisfy the condition for enabling the calculation of an effective exposure correction amount. In this case, there may be a large error between the average brightness value of the target face region, and the average brightness value of the entire face region in a case where the person wears neither the mask nor the sunglasses.

To address the issue, in the present exemplary embodiment, a ratio of the target face region to the entire face region is used as a condition for enabling the calculation of an effective exposure correction amount based on the target face region. More specifically, in the present exemplary embodiment, in a case where the ratio of the target face region to the entire face region is a predetermined ratio or less, it is determined that an effective exposure correction amount cannot be calculated from the target face region. Thus, in the present exemplary embodiment, in a case where the ratio of the target face region to the entire face region is the predetermined ratio or less, the exposure correction amount is calculated based on the entire face region instead of the target face region. The predetermined ratio of the target face region to the entire face region is, for example, ½. More specifically, in the present exemplary embodiment, in a case where the ratio of the target face region to the entire face region is ½ or less, the exposure correction unit 230 calculates the exposure correction amount based on the entire face region.

In a case where the face detection accuracy reduces because the person wears both a mask and sunglasses, in order to increase the human body detection accuracy, an average brightness value of a human body region detected in the human body detection processing is calculated, and the exposure correction may be performed based on the average brightness value of the human body region.

In a third exemplary embodiment, a case where a plurality of face images is detected from an image will be described. A system configuration, a functional block configuration, and a hardware configuration in the third exemplary embodiment are similar to those according to the first exemplary embodiment illustrated in FIGS. 1, 2, and 3, and diagrams and descriptions thereof will thus be omitted.

In the present exemplary embodiment, in a case where the face detection unit 207 detects a plurality of face images, the exposure correction unit 230 determines the exposure correction amount based on the plurality of face images. One example is that the exposure correction unit 230 determines the exposure correction amount based on the average brightness value of the target face regions respectively identified from the plurality of face images. Another example is that the region identification unit 208 calculates the exposure correction amount based on the average brightness value of the target face regions each having a region size greater than or equal to a predetermined size among the target face regions respectively identified from the plurality of face images. Yet another example is that the exposure correction unit 230 determines the exposure correction amount based on the average brightness value of the target region having the largest region size among the target face regions respectively identified from the plurality of face images. Yet another example is that the exposure correction unit 230 weights the target face regions respectively identified from the plurality of face images, based on the sizes thereof and calculates the exposure correction amount based on the average brightness value calculated from the weighted target face regions. Yet another example is that, in a case where a plurality of face images is detected, the exposure correction unit 230 sets, as a priority region, at least one of the plurality of target face regions respectively identified from the plurality of face images, and calculates the exposure correction amount based on the average brightness value of the target face region set as the priority region.

In a fourth exemplary embodiment, a case where the image capturing apparatus 110 can perform image capturing in a plurality of image capturing modes will be described as an example. In the present exemplary embodiment, a color image capturing mode for performing color image capturing and an infrared image capturing mode for performing infrared image capturing will be described as an example of the plurality of image capturing modes. In the present exemplary embodiment, the image capturing apparatus 110 is assumed to be, for example, a monitoring camera that performs image capturing in the color image capturing mode during the daytime and performs image capturing in the infrared image capturing mode during the nighttime.

In a case where the image capturing apparatus 110 performs image capturing by switching between the color image capturing mode and the infrared image capturing mode as described above, in order to calculate a correct exposure correction amount for a face, it is desirable to change the target brightness value for the average brightness value of the face region depending on whether the image capturing mode is the color image capturing mode or the infrared image capturing mode. It is also desirable to change the exposure correction depending on whether the image capturing mode is the color image capturing mode or the infrared image capturing mode.

In the present exemplary embodiment, for example, in a case where the image capturing apparatus 110 is set to the infrared image capturing mode, the information processing apparatus 100 calculates the exposure correction amount based on the average brightness value of the target face region as described above. On the other hand, for example, in a case where the image capturing apparatus 110 is set to the color image capturing mode, the information processing apparatus 100 performs the exposure correction corresponding to the facial skin color in the face image detected from the image.

In this way, the information processing apparatus 100 according to the present exemplary embodiment can change the exposure correction for a face depending on the image capturing mode of the image capturing apparatus 110.

According to the exemplary embodiments of the present disclosure, it is possible to perform an exposure setting that enables obtaining a correctly exposed face image even in a case where a person wears an item on the face.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-186310, filed Nov. 22, 2022, which is hereby incorporated by reference herein in its entirety.

What is claimed is:

1. An information processing apparatus comprising:
one or more memories storing instructions; and
one or more processors that, upon execution of the stored instructions, are configured to:
detect a face region of a person included in a captured image,
detect, from the face region in the captured image, a region of an item that the person wears,
identify a target face region obtained by excluding the region of the item from the face region in the captured image,
determine, based on the target face region, an exposure correction amount relating to an exposure setting of an image capturing apparatus that obtains the captured image, and
perform an exposure correction for the image capturing apparatus based on the determined exposure correction amount.

2. The information processing apparatus according to claim 1, wherein at least one of a region of a mask and a region of sunglasses is detected as the region of the item.

3. The information processing apparatus according to claim 1, wherein the exposure correction amount is calculated based on an average brightness value of the target face region.

4. The information processing apparatus according to claim 1, wherein, in a case where a ratio of an area of the target face region to an area of the face region is a predetermined ratio or less, the exposure correction amount is determined based on the face region.

5. The information processing apparatus according to claim 1, wherein, in a case where a plurality of the face regions is detected from the captured image, the exposure correction amount is determined based on a plurality of the target face regions respectively identified from the plurality of face regions.

6. The information processing apparatus according to claim 5, wherein the exposure correction amount is calculated based on an average brightness value of one or a plurality of target face regions each having a predetermined region size or greater among the plurality of target face regions respectively identified from the plurality of face regions.

7. The information processing apparatus according to claim 5, wherein the exposure correction amount is calculated based on weighting corresponding to each of sizes of the plurality of target face regions respectively identified from the plurality of face regions, and an average brightness value of the plurality of target face regions to each of which the corresponding weighting is applied.

8. The information processing apparatus according to claim 5, wherein the exposure correction amount is calculated based on an average brightness value of at least one target face region set as a priority region among the plurality of target face regions respectively identified from the plurality of face regions.

9. The information processing apparatus according to claim 1, wherein, in a case where a plurality of the face regions is detected, a number of face regions, among the plurality of face regions, from each of which the target face region is to be identified is determined based on at least one of a size of each of the plurality of face regions and a detected position of each of the plurality of face regions.

10. The information processing apparatus according to claim 1, wherein the target face region is identified based on at least one of a position of each of eyes, a nose, a mouth included in the face region and a likelihood of each of the eyes, the nose, and the mouth.

11. The information processing apparatus according to claim 1, wherein execution of the stored instructions further configures the one or more processors to perform determination processing to determine whether the person detected from the captured image and a registered person are a same person based on a degree of similarity between a feature quantity of the face region and a feature quantity of the registered person.

12. The information processing apparatus according to claim 11,
wherein whether an exposure of the target face region is correct is determined based on the captured image obtained by the image capturing apparatus with the exposure setting performed based on the exposure correction amount, and
wherein the determination processing is performed in a case where the exposure of the target face region is determined to be correct.

13. The information processing apparatus according to claim 11, wherein the determination processing is performed in a case where an average brightness value of the target face region is within a predetermined brightness range.

14. The information processing apparatus according to claim 11, wherein the determination processing is not performed in a case where the target face region is not within a predetermined setting range in the captured image.

15. The information processing apparatus according to claim 1, wherein execution of the stored instructions further configures the one or more processors to set, based on an image capturing mode of the image capturing apparatus, whether to perform processing for determining the exposure correction amount.

16. The information processing apparatus according to claim 15,
wherein the image capturing mode includes a color image capturing mode and an infrared image capturing mode, and
wherein the processing for determining the exposure correction amount is performed in a case where the image capturing mode of the image capturing apparatus is the infrared image capturing mode, and the processing for determining the exposure correction amount is not performed in a case where the image capturing mode of the image capturing apparatus is the color image capturing mode.

17. An information processing method comprising:
detecting a face region of a person included in a captured image;
detecting, from the face region in the captured image, a region of an item that the person wears;
identifying a target face region obtained by excluding the region of the item from the face region in the captured image;
determining, based on the target face region, an exposure correction amount relating to an exposure setting of an image capturing apparatus that obtains the captured image; and
performing an exposure correction for the image capturing apparatus based on the determined exposure correction amount.

18. A non-transitory computer-readable storage medium storing instructions that, when executed by one or more processors, configure the one or more processors to execute an information processing method comprising:
detecting a face region of a person included in a captured image;
detecting, from the face region in the captured image, a region of an item that the person wears;
identifying a target face region obtained by excluding the region of the item from the face region in the captured image;
determining, based on the target face region, an exposure correction amount relating to an exposure setting of an image capturing apparatus that obtains the captured image; and
performing an exposure correction for the image capturing apparatus based on the determined exposure correction amount.
